(19) United States
(12) Patent Application Publication
(10) Pub. No.: US 2024/0326206 A1
(43) Pub. Date: Oct. 3, 2024

(54) TOOL AND METHOD FOR REMOVING PACKING FROM THE FLUID END OF A PLUNGER PUMP

(71) Applicant: Servando Rodriguez, Midland, TX (US)

(72) Inventor: Servando Rodriguez, Midland, TX (US)

(21) Appl. No.: 18/127,099

(22) Filed: Mar. 28, 2023

(51) Int. Cl. B25B 27/00; B25B 27/02; F04B 53/22

(52) U.S. Cl. CPC B25B 27/0028; B25B 27/023; F04B 53/22

(57) ABSTRACT

A packing removal tool for removing packing from a fluid end of a plunger pump includes a rod which is elongated between a front end and a rear end of the rod. A ram is coupled to the front end of the rod, and the ram is shaped such that the ram is configured for inserting into a channel of the fluid end through an access opening of the fluid end and engaging the packing. A disc is coupled to the rod and is positioned between the front and rear ends of the rod. The disc has outer threads on an outer annular surface of the disc which are configured for threadedly engaging internal threads of the channel of the fluid end adjacent to the access opening. The disc is also movable forwardly and rearwardly with respect to the rod.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to packing removal tools and more particularly pertains to a new packing removal tool for removing packing from a fluid end of a plunger pump.

### (2) Description of Related Art Including Information Disclosed Under 37 CFR 1.97 and 1.98

Positive displacement plunger pumps, also referred to as plunger pumps, typically have two sections: a power end and a fluid end. The power end includes a mechanism for reciprocally driving a plunger into and out of the fluid end. When the plunger is driven out of the fluid end, fluid is drawn through an inlet of the fluid end. When the plunger is driven into the fluid end, the fluid is compelled out through an outlet of the fluid end. Check valves are employed to prevent fluid being drawn into the fluid end through the outlet and out of the fluid end through the inlet. The fluid end relies on a type of seal called a packing to surround the plunger near a plunger opening to the fluid end.

The prior art discloses different fluid end packing assemblies for limiting fluid leaks through the plunger opening. The prior art also describes a hydraulically driven assembly for applying variable amounts of pressure to a packing to compensate for pressure variations and other environmental forces acting on the packing, thus improving the life of the packing. The need for replacing packing from time to time, however, is not eliminated. Current methods for removing damaged or worn packing include prying the packing out with improvised tools. An improved tool for removing packing from fluid ends is thus needed.

### BRIEF SUMMARY OF THE INVENTION

An embodiment of the disclosure meets the needs presented above by generally comprising a rod which is elongated between a front end and a rear end of the rod. A ram is coupled to the front end of the rod, and the ram is shaped such that the ram is configured for inserting into a channel of the fluid end through an access opening of the fluid end and engaging the packing. A disc is coupled to the rod and is positioned between the front and rear ends of the rod. The disc has outer threads on an outer annular surface of the disc which are configured for threadedly engaging internal threads of the channel of the fluid end adjacent to the access opening. The disc is also movable forwardly and rearwardly with respect to the rod.

Another embodiment of the disclosure generally comprises a method for removing the packing from the fluid end. The method includes providing a packing removal tool which comprises a rod, a ram, and a disc. The rod is elongated between a front end and a rear end of the rod. The ram is coupled to the front end of the rod. The disc is coupled to the rod and is positioned between the front and rear ends of the rod. The disc is also movable forwardly and rearwardly with respect to the rod. The method further includes the step of inserting the ram and the front end of the rod into the channel of the fluid end through the access opening of the fluid end. The disc is coupled to the fluid end, and the rod is moved with respect to the disc to urge the ram away from the disc. The ram is moved such that the ram engages the packing and urges the packing away from the access opening and out of the channel through a plunger opening of the fluid end. The ram may also be removable from the rod, in which case the method may further comprise removing the ram from the rod through the plunger opening.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top front side perspective view of a packing removal tool according to an embodiment of the disclosure.

FIG. 2 is an exploded view of an embodiment of the disclosure.

FIG. 3 is a side view of an embodiment of the disclosure.

FIG. 4 is a front view of an embodiment of the disclosure.

FIG. 5 is a rear view of an embodiment of the disclosure.

FIG. 6 is an in-use view of an embodiment of the disclosure.

FIG. 7A is a cross-sectional in-use view of an embodiment of the disclosure taken from Arrows 7-7 in FIG. 6.

FIG. 7B is a cross-sectional in-use view of an embodiment of the disclosure taken from Arrows 7-7 in FIG. 6.

FIG. 7C is a cross-sectional in-use view of an embodiment of the disclosure taken from Arrows 7-7 in FIG. 6.

### DETAILED DESCRIPTION OF THE INVENTION

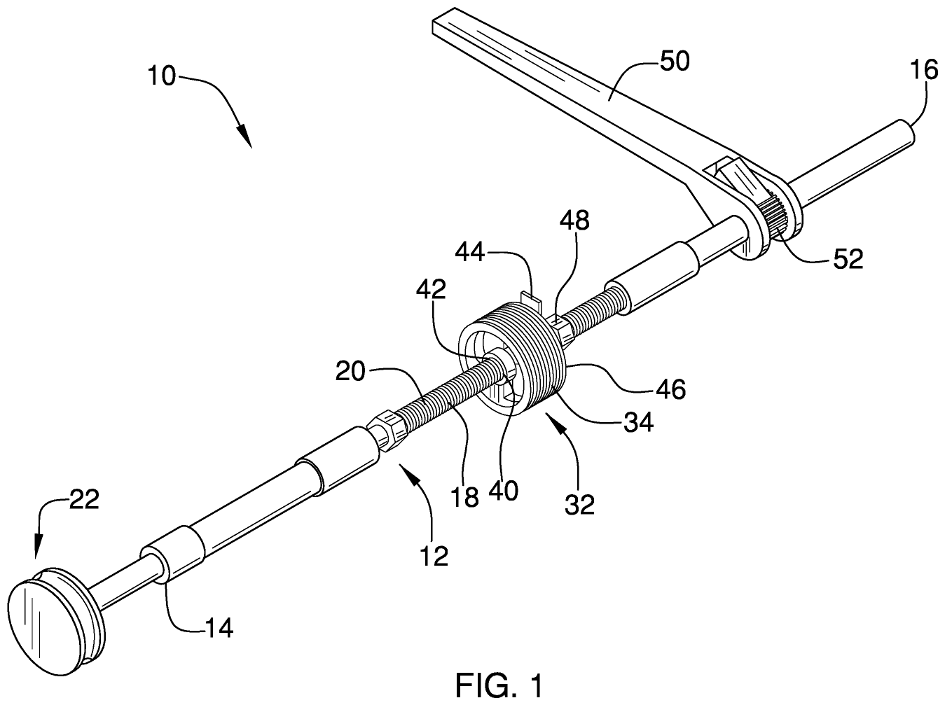

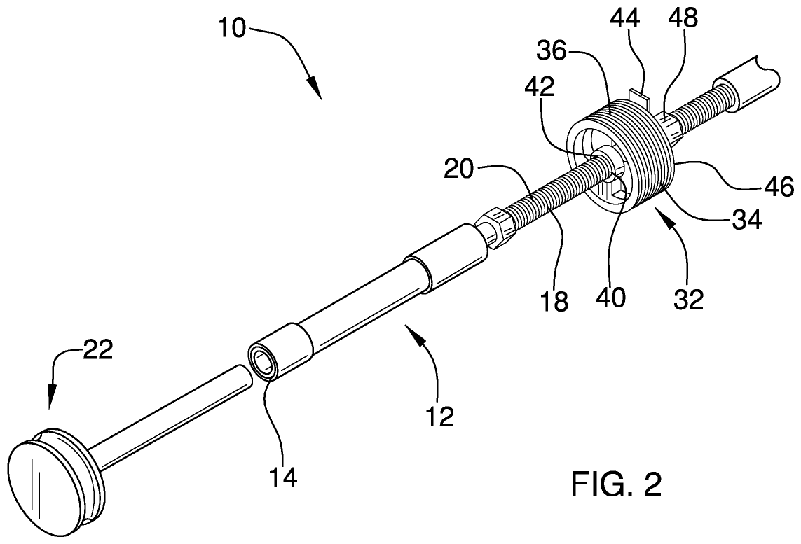

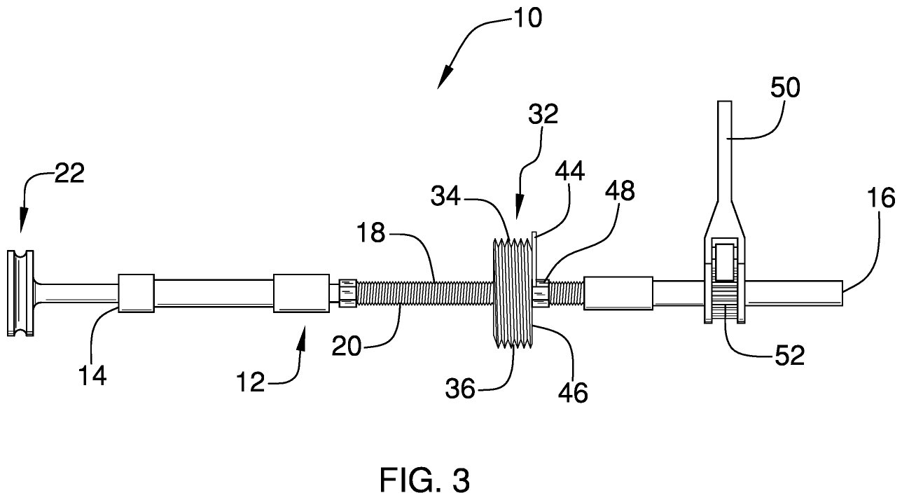

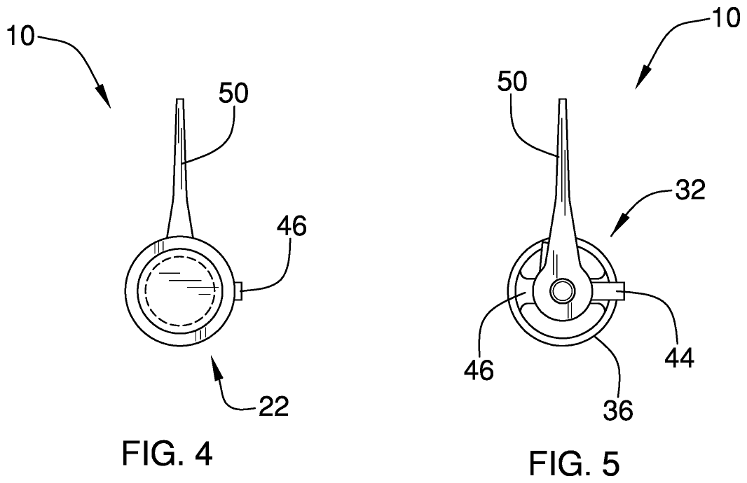

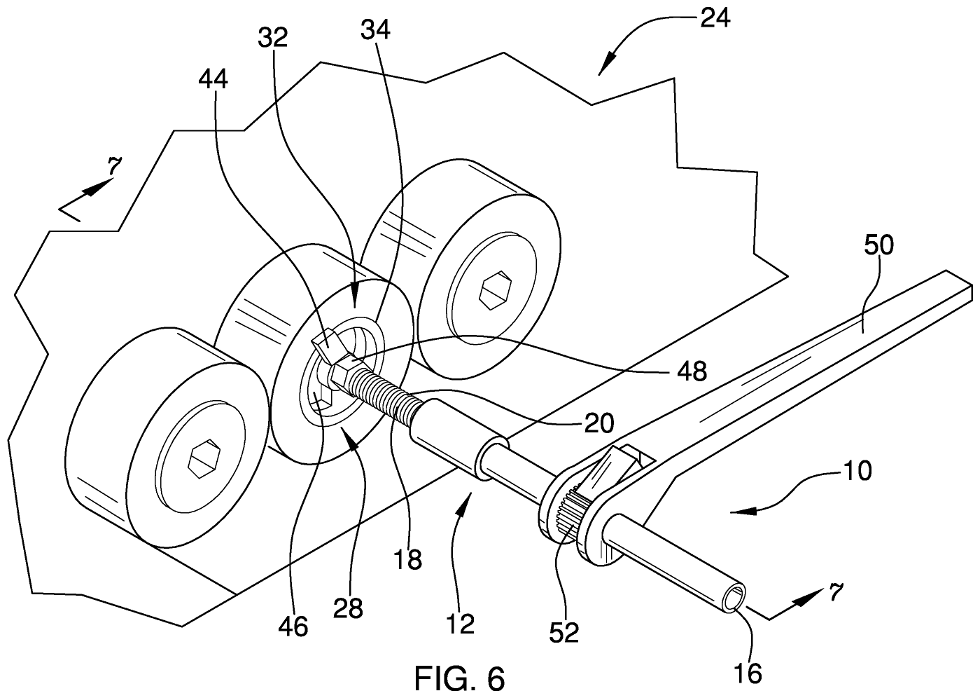

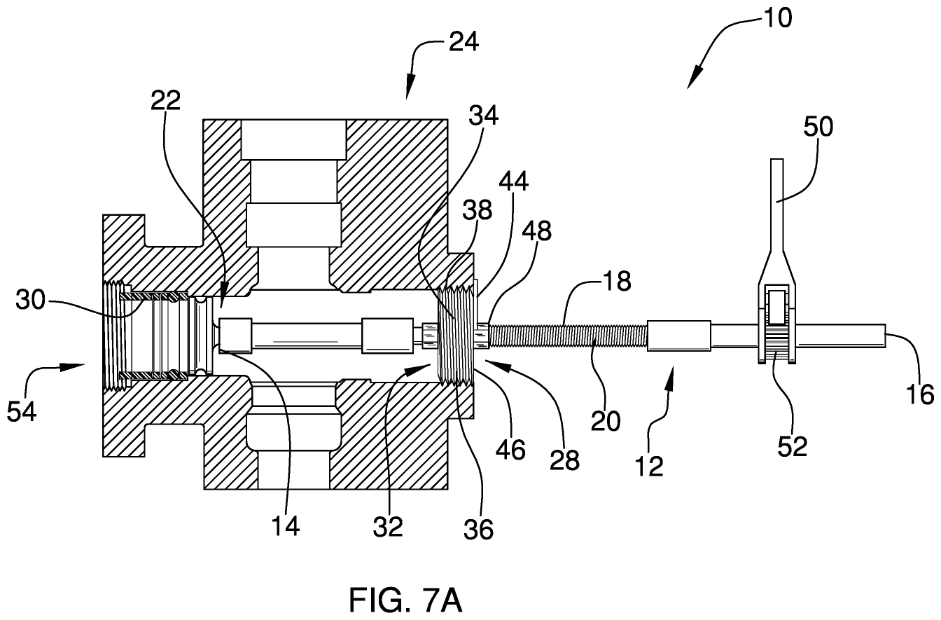

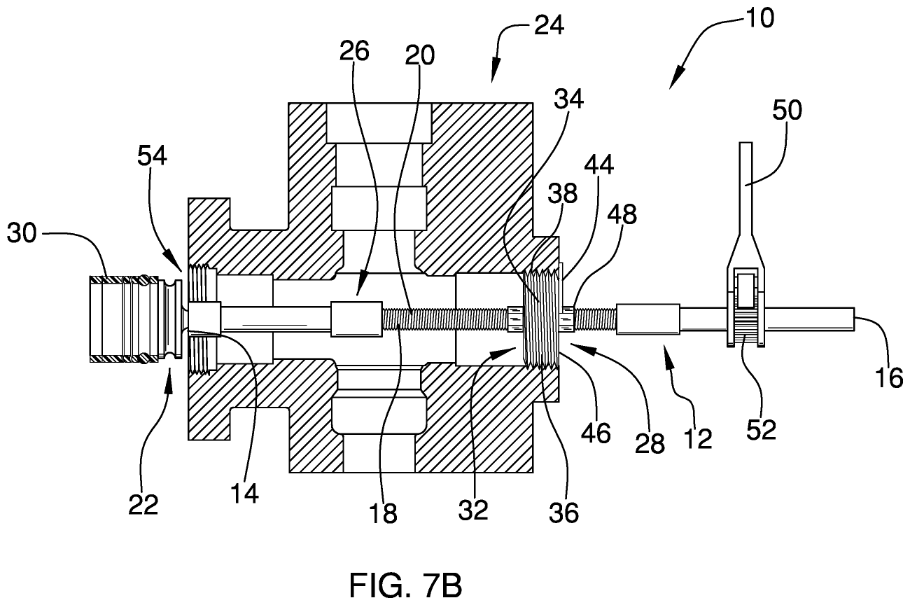

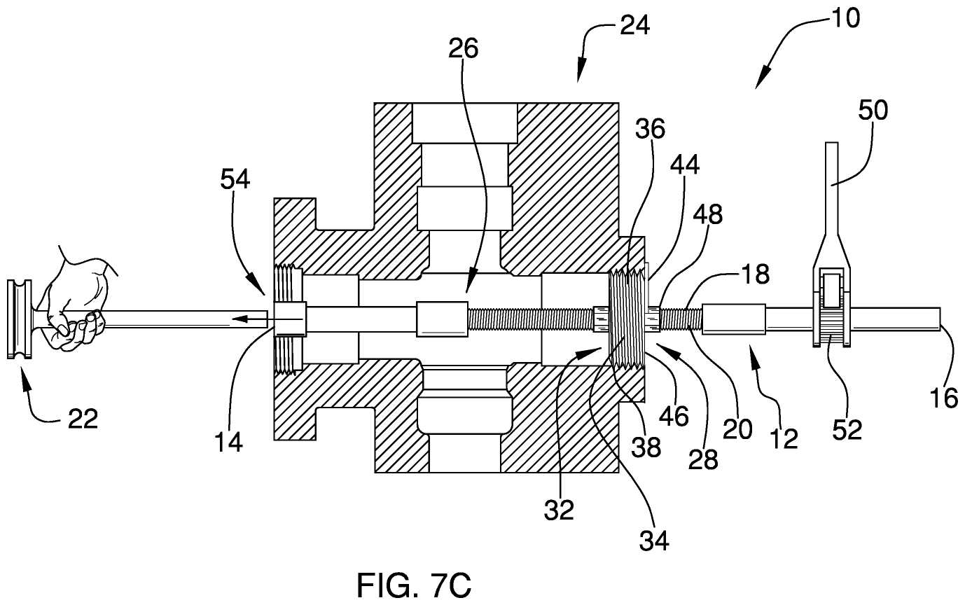

With reference now to the drawings, and in particular to FIGS. 1 through 7C thereof, a new packing removal tool embodying the principles and concepts of an embodiment of the disclosure and generally designated by the reference numeral 10 will be described.

Positive displacement plunger pumps, also referred to as plunger pumps, typically have two sections: a power end and a fluid end. The power end includes a mechanism for reciprocally driving a plunger into and out of the fluid end. When the plunger is driven out of the fluid end, fluid is drawn through an inlet of the fluid end. When the plunger is driven into the fluid end, the fluid is compelled out through an outlet of the fluid end. Check valves are employed to prevent fluid being drawn into the fluid end through the outlet and out of the fluid end through the inlet. The fluid end relies on a type of seal called a packing to surround the plunger near a plunger opening to the fluid end. Fluid ends typically have an access opening positioned opposite the plunger opening across a channel for accessing parts within the fluid end for maintenance or replacement.

As best illustrated in FIGS. 1 through 7C, the packing 30 removal tool 10 generally comprises a rod 12 that is elongated between a front end 14 and a rear end 16 of the rod 12. The front end 14 of the rod 12 is open, and the rod 12 has external threads 18 on an outer surface 20 of the rod 12. A ram 22 is coupled to the front end 14 of the rod 12. The ram 22 is shaped such that the ram 22 is configured for inserting into a channel 26 of a fluid end 24 through an access opening 28 of the fluid end 24 and engaging a packing 30. The ram 22 is removable from the rod 12 and is slidably received into the rod 12 through the front end 14.

A disc 32 is coupled to the rod 12 and is positioned between the front and rear ends 14, 16 of the rod 12. The disc 32 has outer threads 34 on an outer annular surface 36 of the disc 32 which are configured for threadedly engaging internal threads 38 of the channel 26 of the fluid end 24 adjacent to the access opening 28. The disc 32 is movable forwardly and rearwardly with respect to the rod 12. The disc 32 has inner threads 40 on an inner annular surface 42 of the disc 32 which threadedly engage the external threads 18 of the rod 12. A catch 44 is coupled to a rear side 46 of the disc 32, the rear side 46 facing rearwardly with respect to the rod 12. The catch 44 extends laterally with respect to the rod 12 and is configured for engaging the fluid end 24 to inhibit movement of the disc 32 inwardly with respect to the fluid end 24. A nut 48 is coupled to the rear side 46 of the disc 32 and is coaxially aligned with the disc 32. The nut 48 is rotatable to rotate the disc 32 with respect to the rod 12. The nut 48 provides a location for a wrench to engage to facilitate threading the disc 32 into the channel 26 of the fluid end 24.

A lever 50 is coupled to and extends laterally from the rod 12 for turning the rod 12 to rotate the rod 12 with respect to the disc 32 such that the rod 12 urges the ram 22 away from the disc 32. A ratchet 52 couples the lever 50 to the rod 12 such that the lever 50 is pivotable with respect to the rod 12 when the lever 50 is rotated in a first direction and the lever 50 engages the rod 12 when the lever 50 is rotated in a second direction, the second direction being opposite the first direction.

In use, the ram 22 and the front end 14 of the rod 12 are inserted into the channel 26 of the fluid end 24 through the access opening 28. The disc 32 is rotated to thread into the channel 26 through the access opening 28. The lever 50 is rotated in the second direction to engage the rod 12 and rotate it such that the ram 22 is urged away from the disc 32 and toward the packing 30. The catch 44 engages the fluid end 24 to prevent the disc 32 from continuing to travel into the channel 26 when the rod 12 is rotated. The rod 12 is continually moved in this manner such that the ram 22 engages the packing 30 and compels the packing 30 out of the channel 26 of the fluid end 24 through the plunger opening 54. The ram 22 may then be removed from the rod 12 and out of the channel 26 through the plunger opening 54. The disc 32 and the rod 12 may be removed from the channel 26 through the access opening 28.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A packing removal tool for removing a packing from a fluid end of a plunger pump, the packing removal tool comprising:
a rod being elongated between a front end and a rear end of said rod;
a ram being coupled to said front end of said rod, said ram being shaped such that said ram is configured for inserting into a channel of the fluid end through an access opening of the fluid end and engaging the packing; and
a disc being coupled to said rod, said disc being positioned between said front and rear ends of said rod, said disc having outer threads on an outer annular surface of said disc, said outer threads of said disc being configured for threadedly engaging internal threads of the channel of the fluid end adjacent to the access opening, said disc being movable forwardly and rearwardly with respect to said rod.

2. The tool of claim 1, wherein said ram is removable from said rod.

3. The tool of claim 2, wherein said front end of said rod is open, said ram being slidably received into said rod through said front end.

4. The tool of claim 1, wherein said rod has external threads on an outer surface of said rod, said disc having inner threads on an inner annular surface of said disc, said inner threads threadedly engaging said external threads of said rod.

5. The tool of claim 1, further comprising a catch being coupled to a rear side of said disc, said rear side facing rearwardly with respect to said rod, said catch extending laterally with respect to said rod, said catch being configured for engaging the fluid end to inhibit movement of said disc inwardly with respect to the fluid end.

6. The tool of claim 4, further comprising a lever being coupled to and extending laterally from said rod for turning said rod to rotate said rod with respect to said disc such that said rod urges said ram away from said disc.

7. The tool of claim 6, further comprising a ratchet coupling said lever to said rod such that said lever is pivotable with respect to said rod when said lever is rotated in a first direction and said lever engages said rod when said lever is rotated in a second direction, said second direction being opposite said first direction.

8. The tool of claim 4, further comprising a nut being coupled to said rear side of said disc, said nut being coaxially aligned with said disc, said nut being rotatable to rotate said disc with respect to said rod.

9. A packing removal tool for removing a packing from a fluid end of a plunger pump, the packing removal tool comprising:
a rod being elongated between a front end and a rear end of said rod, said front end of said rod being open, said rod having external threads on an outer surface of said rod;
a ram being coupled to said front end of said rod, said ram being shaped such that said ram is configured for inserting into a channel of the fluid end through an access opening of the fluid end and engaging the packing, said ram being removable from said rod, said ram being slidably received into said rod through said front end;
a disc being coupled to said rod, said disc being positioned between said front and rear ends of said rod, said disc having outer threads on an outer annular surface of said disc, said outer threads of said disc being configured for threadedly engaging internal threads of the channel of the fluid end adjacent to the access opening, said disc being movable forwardly and rearwardly with respect to said rod, said disc having inner threads on an inner annular surface of said disc, said inner threads threadedly engaging said external threads of said rod;
a catch being coupled to a rear side of said disc, said rear side facing rearwardly with respect to said rod, said catch extending laterally with respect to said rod, said catch being configured for engaging the fluid end to inhibit movement of said disc inwardly with respect to the fluid end;
a lever being coupled to and extending laterally from said rod for turning said rod to rotate said rod with respect to said disc such that said rod urges said ram away from said disc;
a ratchet coupling said lever to said rod such that said lever is pivotable with respect to said rod when said lever is rotated in a first direction and said lever engages said rod when said lever is rotated in a second direction, said second direction being opposite said first direction; and
a nut being coupled to said rear side of said disc, said nut being coaxially aligned with said disc, said nut being rotatable to rotate said disc with respect to said rod.

10. A method for removing a packing from a fluid end of a plunger pump, the method comprising:
providing a packing removal tool, wherein the packing removal tool comprises:
a rod being elongated between a front end and a rear end of the rod;
a ram being coupled to the front end of the rod; and
a disc being coupled to the rod, the disc being positioned between the front and rear ends of the rod, the disc being movable forwardly and rearwardly with respect to the rod;
inserting the ram and the front end of the rod into a channel of the fluid end through an access opening of the fluid end;
coupling the disc to the fluid end;
moving the rod with respect to the disc to urge the ram away from the disc; and
engaging the packing with the ram to urge the packing away from the access opening and out of the channel through a plunger opening of the fluid end.

11. The method of claim 10, wherein the ram is removable from the rod, the method further comprising removing the ram from the rod through the plunger opening.
